(19) United States
(12) Patent Application Publication
(10) Pub. No.: US 2014/0288823 A1
(43) Pub. Date: Sep. 25, 2014

(54) COMPONENT REGISTRATION SYSTEM FOR A MACHINE

(71) Applicant: Caterpillar Inc., PEORIA, IL (US)

(72) Inventors: CHRISTI MICHELLE WILSON, CHILLICOTHE, IL (US); MARK EUGENE JUCHEMS, TREMONT, IL (US); ERIC JOHN PHILIPS, WASHINGTON, IL (US)

(21) Appl. No.: 14/306,290

(22) Filed: Jun. 17, 2014

(51) Int. Cl. G01C 21/20

(52) U.S. Cl. CPC G01C 21/20
USPC 701/468

(57) ABSTRACT

A component registration system for a machine, is provided. The system comprises: a component installed on the machine, a data system located remote from the machine and configured to communicate with the machine, a locating device installed on the machine and configured to determine global position of the machine, a controller installed on the machine, and a cellular device including a service management tool. The controller collects information from the component, collects determined global position information from the locating device, and conveys the collected information to the data system. The service management tool on the cellular device includes a proximity search feature that provides selective registration of the component based on global position of the machine and proximity of the machine to the cellular device.

### TECHNICAL FIELD

The present disclosure relates generally to machine monitoring system. More specifically, the present disclosure relates to a component registration system for a machine.

### BACKGROUND

Timely repair and maintenance of assets are parts of operating a successful business. Some assets may include a fleet of machines, such as construction machines, passenger vehicles, vocational trucks, and other machines known in the art. Execution of inspections, completion of maintenance, and repair requirements completed in a timely and consistent fashion may result in lower running costs and enhanced vehicle efficiency. A monitoring system to periodically monitor the health of the machines, to maintain and repair of the machines may be developed, to monitor one or more components that may require periodic service for efficient and cost-effective operation. The service may include, but is not limited to, a phone service, an internet service, a locating service, a health monitoring and/or a reporting service. However, for billing, reporting, activation, and/or registration purposes, the one or more components may require registration to the owner or manager of the as set/machine.

A component that requires continuous service may be required to be registered with a data system used to monitor the component of the machine. Component registration may be required prior to activation of the monitoring system. The component may include an electronic serial number. In existing component registration systems, a technician may manually enter the electronic serial number information on an interface configured to register the component of the machine. However, manual entry of the serial number for registration of the component may provide opportunity for error. Also at an inconvenient time, the component registration by manual entry may require significant effort from the technician. Hence, manual entry of the serial number of the component may lead to errors and unsuccessful registration of the component.

U.S. Pat. No. 8,131,605 describes a component registration system for a machine, having a component located on the machine, a data system remote from the machine, and a controller mounted on the machine and in communication with the component and the data system. Upon installation of the component onto the machine, the controller automatically collects information from the component and sends the information to the data system to initiate a registration process.

### SUMMARY

The present disclosure is related to a component registration system for a machine. The system includes: a component installed on the machine, a data system located remote from the machine and configured to communicate with the machine, a locating device installed on the machine and configured to determine global position of the machine, a controller installed on the machine, and a cellular device. The controller is configured to collect information from the component, collect the determined global position information from the locating device, and convey the collected information to the data system. The cellular device is configured to communicate with the data system. The cellular device includes a service management tool with a proximity search feature, which is configured to provide selective registration of the component based on the global position of the machine and proximity of the machine to the cellular device.

### BRIEF DESCRIPTION OF THE DRAWINGS

FIG. 1 illustrates an exemplary machine, in accordance with the concepts of the present disclosure;

FIG. 2 illustrates the machine of FIG. 1 with a component registration system, in accordance with the concepts of the present disclosure;

FIG. 3 illustrates an exemplary cellular device of the component registration system of FIG. 2, in accordance with the concepts of the present disclosure; and

FIG. 4 illustrates a flowchart for a method of component registration using the cellular device, in accordance with the concepts of the present disclosure.

### DETAILED DESCRIPTION

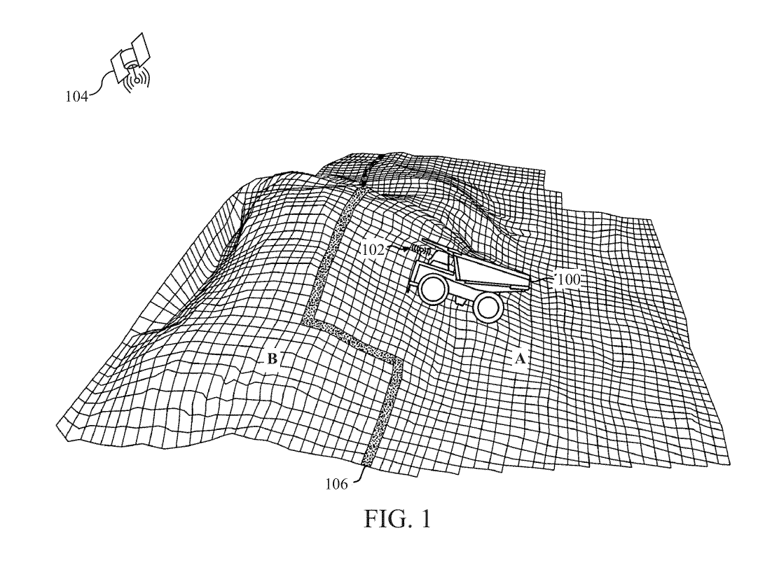

Referring to FIG. 1, there is shown an exemplary machine 100. The machine 100 may embody a stationary or mobile machine configured to perform some type of operation associated with mining, construction, farming, transportation, power generation, or other task known in the art. For example, the machine 100 may be an earth moving work machine, such as: a haul truck (illustrated in FIG. 1), a dozer, a loader, a backhoe, an excavator, a motor grader, or other earth moving machine.

As illustrated in FIG. 1, the machine 100 travels between a first worksite A and a second worksite B. Each of the first worksite A and the second worksite B may include: a mine site, a landfill, a quarry, a construction site, a dealership coverage area, or any other type of worksite known in the art. The machine 100 may include a locating device 102, to monitor the movement of the machine 100. The locating device 102 may determine a global position of the machine 100 and generate a signal indicative thereof. As the machine 100 travels between the first worksite A and second worksite B, the locating device 102 may communicate the generated signal to a satellite 104. During this travel between the first worksite A and the second worksite B, the machine 100 may cross a virtual fence 106, also known as a “geo-fence” that separates the first worksite A from the second worksite B.

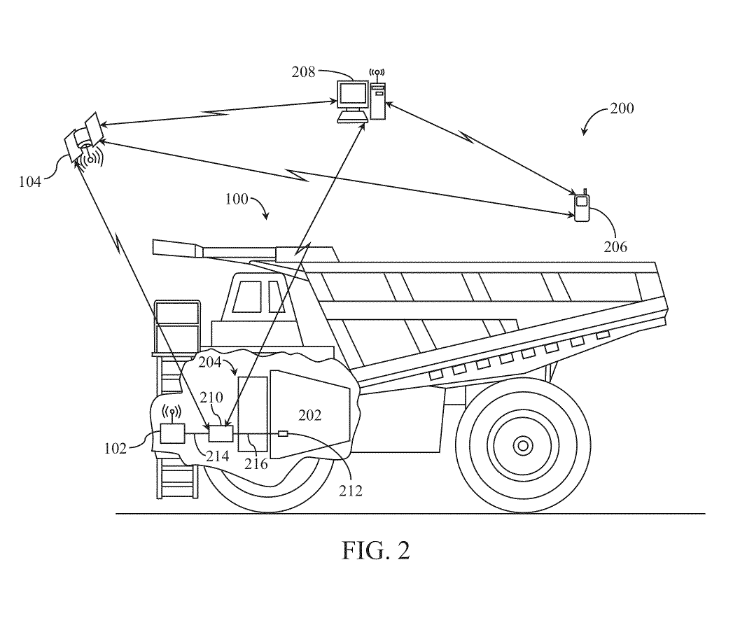

Referring to FIG. 2, there is shown the machine 100 with a component registration system 200. The machine 100 includes the locating device 102, a plurality of components 202, and a component control system 204. The component control system 204 may interact with the component registration system 200. The component registration system 200 may include the satellite 104, a cellular device 206, and a data system 208.

The component control system 204 may include a controller 210 and a plurality of sensing devices 212. The controller 210 may interact with the plurality of sensing devices 212, installed on the plurality of components 202. The plurality of components 202 may be distributed throughout the machine 100. The plurality of sensing devices 212 may be associated with the plurality of components 202. The plurality of components 202 may include, but is not limited to: a work implement, a power source, a transmission, a torque converter, a fluid supply, and/or other components and subsystems of the machine 100. The interaction of the sensing device 212 with the controller 210 enables the controller 210 to gather the information related to certain parameters of the corresponding component 202. The sensing device 212 may automatically gather data from the component 202 of the machine 100. The information gathered by the sensing device 212 may include: machine speed, machine location, electric current and/or voltage levels, fluid (i.e., fuel, oil, etc.) consumption rates, loading levels (i.e., payload value, percent of maximum allowable payload limit, payload history, payload distribution, etc.), transmission output ratio, performed maintenance and/or repair operations, and other such pieces and/or types of information. Additional information may be generated or maintained by the controller 210, such as the time of day, date, and operator information. The gathered data may be indexed relative to the time, day, date, operator information, and/or other pieces of information, to determine the various operational aspects of the machine 100.

Moreover, the controller 210 may gather information related to the global position of the locating device 102. The locating device 102 may include a Global Positioning System (GPS), an Inertial Reference Unit (IRU), a local tracking system, or other known device that receives or determines the global position associated with the machine 100. Also, the locating device 102 may be in communication with the controller 210, to convey a signal indicative of the received or determined global position information to the cellular device 206.

The controller 210 may include a means for monitoring, recording, storing, indexing, processing, and/or communicating the operational aspects of the machine 100 described above. These means may include the plurality of components 202, such as: a memory, one or more data storage devices, a central processing unit, or other components that may be used to run an application.

The controller 210 may also include a means to communicate with the data system 208. For example, the controller 210 may include hardware and/or software that enables data messages to be sent and received through a direct data link (not shown) or a wireless communication link (not shown). The wireless communications occur with the satellite 104. However, the wireless communications may also include infrared and other types of communications that enable the controller 210 to exchange information with the data system 208. It is contemplated that, if desired, a separate module, such as a telematics device, may alternatively be included within the component control system 204, to facilitate the communication of data between the controller 210 and the data system 208.

The controller 210 may also be in communication with the other components of the component control system 204. For example, the controller 210 may be in communication with the locating device 102 and the sensing device 212, respectively, via a first communication line 214 and a second communication line 216. The controller 210 may be configured to send communications to and receive communications from the data system 208, in response to input from the locating device 102 and the sensing device 212. Likewise, the controller 210 is configured to monitor and/or control operation of the plurality of components 202 and/or the locating device 102, in response to communications from the data system 208.

The data system 208 is located remote from the machine 100. The data system 208 may represent one or more computing systems of a business entity associated with the machine 100, such as: a manufacturer, dealer, retailer, owner, service provider, or other entity that generates, maintains, sends, and/or receives information or data associated with the machine 100. In an embodiment, the data system 208 may be: a laptop, a work station, a personal digital assistant, a mainframe, and other computing systems known in the art.

The data system 208 may be in communication with the cellular device 206, which is configured to receive information from and send information to the data system 208. The cellular device 206 is configured to add and register the plurality of components 202 of the machine 100. The information shared between the data system 208 and the cellular device 206 may be related to the component ID of the component 202 of the machine 100. The component ID may be: a serial number, product number, product ID, bar code, QR code, or other similar discoverable ID. When prompted, the cellular device 206 receives the data related to the component 202 from the data system 208. Hence, the component 202 is registered with the data system 208 and added for monitoring.

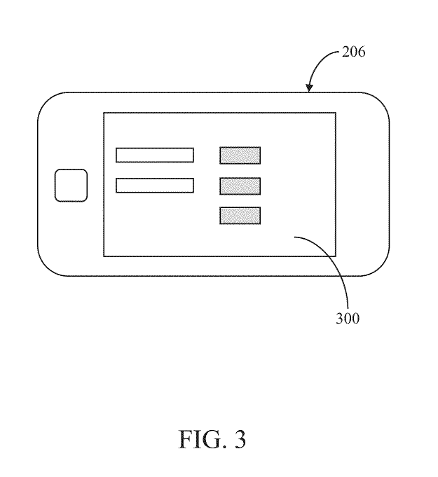

Referring to FIG. 3, there is shown an exemplary cellular device 206. The cellular device 206 is a part of the component registration system 200, and is equipped with features to access a service management tool 300. The component registration system 200, on the cellular device 206, allows an onsite technician or administrator to use the service management tool 300 and register the component 202 of the machine 100 with the data system 208. The service management tool 300 is equipped with certain features for registration of the component 202. For a successful registration, the service management tool 300 determines or acquires the component ID associated with the component 202, to be registered. The service management tool 300 may also allow the onsite technician to manually enter the component ID associated with the component 202, to be registered. Hence, the service management tool 300 offers certain features to enter the component ID of the component 202.

The component ID is entered on the service management tool 300 using features, such as a manual entry feature, a scanned entry feature, and a proximity search feature. The proximity search feature allows an onsite technician to extract information from the data system 208, by automatic submission of the global position of the cellular device 206. The technician may register the component 202 based on global position of the machine 100 and proximity of the machine 100 to the cellular device 206.

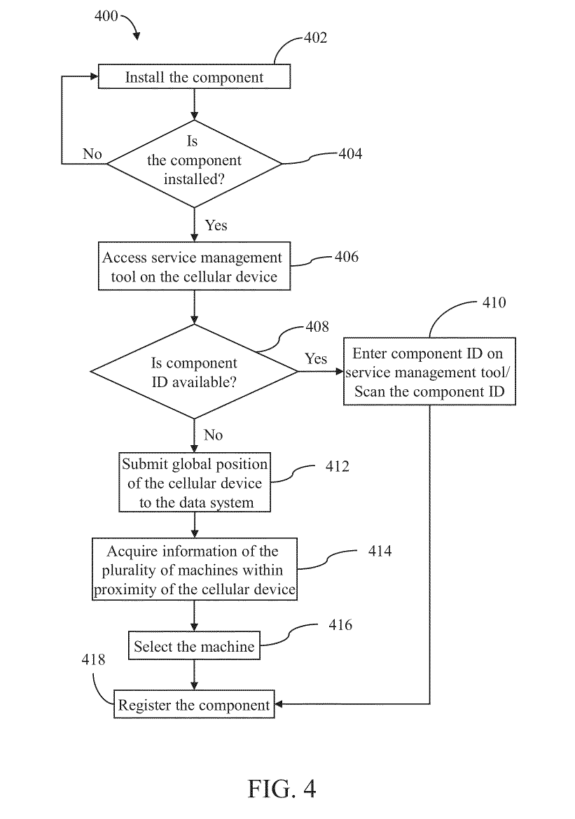

Referring to FIG. 4, there is shown a flowchart for a method 400 of registration of the component 202, using the service management tool 300 on the cellular device 206. The method 400 begins with step 402.

At step 402, the component 202 to be registered, is installed on the machine 100. The method 400 proceeds to step 404.

At step 404, the component registration system 200 prompts the controller 210 to determine if the component 202 is installed. If the component 202 is installed, the method 400 proceeds to step 406. If the component 202 is not installed, the method 400 goes to step 402.

At step 406, the technician accesses the service management tool 300 on the cellular device 206. The method 400 proceeds to step 408.

At step 408, the technician determines if the component ID of the component 202 is available. If the component ID of the component 202 is available, the method 400 proceeds to step 410. If the component ID of the component 202 is not available, the method 400 proceeds to step 412.

At step 410, the technician enters the component ID manually or scans the bar code associated with the component 202. The method 400 proceeds to end step 418.

At step 412, the technician selects the proximity search feature on the service management tool 300. The selection of the proximity search feature on the service management tool 300, automatically submits the global location of the cellular device 206 to the data system 208. The method 400 proceeds to step 414.

At step 414, the service management tool 300 acquires information of the plurality of machines in proximity of the cellular device 206. The information of the plurality of machines is indexed relative to corresponding global locations. The method 400 proceeds to step 416.

At step 416, the technician selects the machine 100, equipped with the component 202 to be registered, based on the global location of the machine 100 and proximity of the machine 100 to the cellular device 206. The method 400 proceeds to end step 418.

At end step 418, upon selection of the machine 100, the component ID is shown in the designated field and the technician selects the component ID. Upon selection, the component 202 is registered with the data system 208.

### INDUSTRIAL APPLICABILITY

The disclosed component registration system 200 provides for registration of the component 202 of the machine 100. The component registration system 200 is configured to register the component 202 of the machine 100 by the cellular device 206.

In operation, prior to component registration of the component 202 of the machine 100, the technician may determine the status of installation of the component 202 on the machine 100. Upon determination that the component 202 is installed on the machine 100, the technician initiates the component registration. The technician accesses the service management tool 300 on the cellular device 206. Prior to initiation of the component registration, the technician is required to decide the mode of component registration. The technician determines if the component ID is discoverable on board of the component 202. In such a situation, the technician manually enters the component ID of the component 202 in the designated field on the service management tool 300 and registers the component 202. In an embodiment, the technician may also scan the barcode on the component 202 to register the component 202. The technician may also determine the component ID of the component 202 by the proximity search feature. This feature is beneficial in situations when the component ID of the component 202 of the machine 100 is not discoverable. Upon selection of the proximity search feature, the global position of the cellular device 206 is automatically submitted to the data system 208, via the satellite 104. Upon receipt of the global location of the cellular device 206, the data system 208 processes the information of the plurality of machines in the proximity of the cellular device 206. The information of the plurality of machines is indexed relative to corresponding global locations and is sent to the cellular device 206, via the satellite 104. The above mentioned information is displayed on the service management tool 300 of the cellular device 206. The technician selects the machine 100 with the component 202, to be registered. The selection is made on the basis of the global position of the machine 100 and proximity of the machine 100 to the cellular device 206. After the selection is made, the component ID is displayed in the designated field on the service management tool 300. The technician then selects the component ID on the service management tool 300. Upon selection of the component ID, the component 202 is registered with the data system 208.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A component registration system for a machine, the system comprising:
a component installed on the machine;
a data system located remote from the machine and configured to communicate with the machine;
a locating device installed on the machine and configured to determine global position of the machine;
a controller installed on the machine, the controller is configured to collect information from the component, collect determined global position information from the locating device, and convey the collected information to the data system; and
a cellular device including a service management tool having a proximity search feature and being configured to communicate with the data system, wherein the service management tool is configured to provide selective registration of the component based on global position of the machine and proximity of the machine to the cellular device.
